(19) United States
(12) Patent Application Publication
(10) Pub. No.: US 2025/0045666 A1
(43) Pub. Date: Feb. 6, 2025

(54) SYSTEM AND METHOD FOR MODELING AND MANAGING INFORMATION SECURITY RISKS

(71) Applicant: GOSECURE, INC., San Diego, CA (US)

(72) Inventor: Patrick LI-CHEONG-MAN, Montreal (CA)

(21) Appl. No.: 18/795,113

(22) Filed: Aug. 5, 2024

Related U.S. Application Data
(60) Provisional application No. 63/530,922, filed on Aug. 4, 2023.

(51) Int. Cl. G06Q 10/0635; G06F 21/57

(52) U.S. Cl. CPC G06Q 10/0635; G06F 21/577

(57) ABSTRACT

The system and method identifies and manages information security risks of existing information systems. The method includes obtaining and synthesizing information security and cybersecurity frameworks to obtain a normalized information security framework. The method also includes obtaining information on existing information systems. The method also includes generating, from the information, based on the normalized information security framework, and customer business context, a risk model that is structured to account for customers' information security ecosystem. The method also includes analyzing the risk model's graph structures to identify information security risk. The method also includes identifying and proposing prioritizing changes to the existing information systems to address the identified risk.

### RELATED APPLICATION

This application claims priority to U.S. Provisional Patent Application No. 63/530,922, filed Aug. 4, 2023, titled “SYSTEMS AND METHOD FOR MODELING AND MANAGING INFORMATION SECURITY RISKS,” which is incorporated by reference herein in its entirety.

### TECHNICAL FIELD

The invention relates to systems and methods for protecting information systems, and is more particularly, but not by way of limitation, directed to technology for modeling, protecting, and managing information security risks.

### BACKGROUND

Information security is the protection of information and information systems from unauthorized access, use, disclosure, disruption, modification, or destruction in order to provide confidentiality, integrity, and availability. Information security teams face the challenge of preparing for, identifying and responding to the increasingly sophisticated threats posed by ransomware, phishing, social engineering and other cyber-attacks. Rapid and effective mitigation can mean the difference between just another day at the office and lasting catastrophic damage to an organization.

### SUMMARY

Accordingly, there is a need for tools, systems and methods for managing information security risks. There is a need for systems and services that test, assess and/or improve information security posture. Tools that proactively identify, block and report potential breaches can help remove or contain potential threats in the early stages of an attack, along with analytics and forensics tools that predict threat intentions and help pinpoint root causes. Described herein are techniques for implementing information security risk modeling tool that take into account organizational context and business objectives. These techniques can be used to determine information security posture with or without compliance information. Systems according to the techniques described herein can be used to assess clients' information security posture through a variety of methodologies, such as NIST CSF, ISO/IEC27001, PCI-DSS, Mitre ATT&CK Framework. Also described herein is a framework to devise custom methodologies that better respond to client requirements. These techniques have a variety of applications, such as answering how a PCI-DSS compliance audit contributes to an NIST CSF assessment, simulating how an outsourced service or project will improve cybersecurity posture, prioritizing cybersecurity initiatives, calculating annual loss expectancy, and comparing different organizations in an industry.

One or more embodiments of the invention are directed to an improved method and system for managing information security risks. According to some embodiments, a method is provided for identifying and addressing information security risks of existing information systems. The method includes obtaining a plurality of information security and/or cybersecurity frameworks. The method also includes synthesizing the plurality of information security and/or cybersecurity frameworks to obtain at least one normalized information security framework. The method also includes obtaining information on existing information systems. The method also includes generating, from the information, based on the normalized information security framework, and customer business context, a risk model that is structured to account for customers' information security ecosystem. The method also includes analyzing the risk model's graph structures to identify information security risk (including cybersecurity risk). The method also includes identifying and proposing prioritizing changes to the existing information systems (including computer systems) to attempt to address the identified risk.

In some embodiments, each information security and cybersecurity framework can include a taxonomy of risks, controls and/or assets.

In some embodiments, synthesizing the plurality of information security and cybersecurity frameworks uses predetermined libraries of categorizations and templates.

In some embodiments, the normalizing comprises addressing biases and variability across the plurality of information security and cybersecurity frameworks.

In some embodiments, the risk model includes a multipartite graph that in turn includes nodes representing risks, controls and/or assets, and edges representing relationships between the nodes.

In some embodiments, analyzing the risk model's graph structures includes traversing the risk model's graph structures to identify risk entries for risk simulations, and populating information in the risk entries at least in part from a risk profile associated with the existing information systems.

In some embodiments, the risk profile is customizable by an operator of the existing information systems.

In some embodiments, the risk profile includes templated risk-profile likelihood parameters per risk categorization and per NAICS categorization. The risk-profile likelihood parameters are customizable per client context, and wherein data for the risk-profile likelihood parameters includes ranges for controls.

In some embodiments, a client's information security business context is represented on a client model (which may include multipartite graphs within it). The client model may be populated with risk profile information (including statistical information) associated with its existing information systems and used for statistical analysis of risk.

In some embodiments, the statistical analysis includes identifying one or more control sets that are most correlated to most significant risks, projecting the one or more control sets into a copy of a current client model, and forecasting risk adjusted by one or more control sets by reapplying the risk methods used to generate the risk forecast of the current client model.

In some embodiments, the statistical analysis includes generating risks from scoped portions of the client model, and aggregating, managing, and/or filtering lists of risks and their uncertain parameters, such as probabilities, duration ranges, and impact ranges.

In some embodiments, the statistical analysis includes forecasting probabilities and financial impacts by repeatedly simulating over a multiplicity of uncertain outcomes occurring across complex systems.

In some embodiments, the statistical analysis includes storing and reusing random outputs generated in simulations towards standardizing control projection comparison.

In some embodiments, the statistical analysis includes performing a series of trials that simulates occurrence and impact of potential risk events, and for each trial, summarizing simulated loss occurrences.

In some embodiments, the information on the existing information systems is updated and/or obtained from one or more compliance audits or assessments of security risks for the existing information systems.

In some embodiments, the results of a risk assessment are reorganized per predefined categories, including predefined security categories or categories defined within the client model.

In some embodiments, the method further includes autogenerating risk events based on relationships between modelled asset and risk categorizations. The risk categorizations are related to one or more asset categorizations.

In some embodiments, the method further includes adjusting a plurality of risk categorizations based on a single control categorization. For example, the client model has the relation specified between the controls in place and the risks at play. One security control may help address a number of risks (e.g., “security awareness, education and training” can help mitigate both the risk of “Social Engineering” and “Misc. Errors”, a well configured/maintained cluster of firewalls may help reduce the particular likelihood of incident/breaches for a number of systems within the network, and so on). Therefore, if one control is tied to a number of risks, and that control is greatly improved, then the risk factor for the risks associated with that control would diminish.

In some embodiments, the method further includes adjusting a single risk categorization based on a plurality of control categorizations, including handling residual risk likelihoods from adjacent controls using a weighted average mechanism.

In some embodiments, the method further includes adjusting risk categorizations based on layered control categorizations, including handling residual risk likelihoods from layered controls using a probability calculation that both controls occur.

In some embodiments, the method further includes adjusting one or more risk-profile parameters according to related controls, including decreasing generic risk-profile likelihood parameters based on quality of related control, mitigating impact parameters by insurance coverage, and mitigating event duration parameters by incident response.

In some embodiments, the method further includes providing interfaces to the client model and an associated risk profile. In some embodiments, this step includes scoping sections of the client model and the associated risk profile. Some embodiments use templates that parameterize categories of the client model and the associated risk profile that are associated with a service. In some embodiments, the method further includes providing evaluation guidelines or parameters using evaluation templates that define how to assess scoped categories. In some embodiments, the method further includes normalizing correlated information for translating equivalent evaluation results between disparate evaluation methodologies.

Some embodiments generate assessments for existing control framework standards based on the results of assessments performed for other control framework standards.

In some embodiments, the method further includes generating an assessment of how different audits in an operator's context for the existing information systems are related to one another.

In some embodiments, the method further includes interfacing with, and providing the client model and associated risk profile, to one or more services (e.g., e-mail protection, managed detection and response, managed perimeter defense, Vulnerability Management as a Service (VMaaS), automation of patching assessment scoring from system coverage, patch level, and timeliness statistics, threat modeler including providing supplementary tactical threat intelligence information and context, and privacy practice assessment that layers onto and assesses an operator's privacy business context).

In some embodiments, identifying potential changes (e.g., control implementations, etc.) to the existing information system (including computer systems) to address the identified risk includes presenting the identified risk to an operator of the existing information systems, presenting risk remediation options (i.e., proposed control sets), to enable them to make informed business decision on risk treatment investments.

In some embodiments, the method further includes generating and displaying a visualization of forecast for the identified risk in different representations, including comparison in relation to client risk tolerances.

In some embodiments, the visualization is presented on a per risk basis or a per risk subset basis.

In some embodiments, identifying potential changes to the existing information systems (including computer systems) to address the identified risk includes prioritizing information security (including cybersecurity) initiatives corresponding to the identified risk.

In some embodiments, the method further includes identifying potential changes to the existing information systems (including computer systems) to address the identified risk includes computing and displaying expenditures, annual loss expectancy, return on investment, based on control projections and cost estimations, and/or a comparison to other organization in a same industry as the client, for the identified risk.

In some embodiments, the method further includes identifying potential changes to the existing information systems (including computer systems) to address the identified risk includes simulating how an outsourced service or project is likely to improve a client's information security (including cybersecurity) posture with respect to the identified risk.

In some embodiments, a computer system has one or more processors, memory, and a display. The one or more programs include instructions for performing any of the methods described herein.

In some embodiments, a non-transitory computer readable storage medium stores one or more programs configured for execution by a computer system having one or more processors, memory, and a display. The one or more programs include instructions for performing any of the methods described herein.

### BRIEF DESCRIPTION OF THE DRAWINGS

FIG. 1 is a schematic diagram of an example system for modeling and managing information security risks, according to some embodiments;

FIG. 2 is a system diagram of an example information security risk manager, according to some embodiments;

FIG. 3 is a block diagram of example customer systems, according to some embodiments;

FIG. 4 is a schematic diagram of a system for information security risk management, according to some embodiments;

FIG. 5 is a schematic diagram of an information security assessment system, according to some embodiments;

FIG. 6 is a schematic diagram of services interfaces, according to some embodiments;

FIG. 7 is a schematic diagram of a probabilistic risk engine, according to some embodiments;

FIG. 8 is an example graphical visualization generated by a probabilistic risk visualizer, according to some embodiments;

FIG. 9 is a schematic diagram of a decision making system, according to some embodiments;

FIG. 10 is an example graphical representation for control-adjusted risk projection and ROSI for two sets of proposed controls, according to some embodiments;

FIG. 11 is a schematic diagram of example interfaces to a threat modeler, according to some embodiments;

FIG. 12 shows example screenshots for entry of standards and frameworks, according to some embodiments;

FIG. 13 shows a table for an example probabilistic risk register, according to some embodiments;

FIG. 14 shows a table of example results from a probabilistic risk simulator, according to some embodiments;

FIG. 15 shows example graph plots output by a probabilistic risk visualizer, according to some embodiments;

FIG. 16 shows example visualization for loss exceedance, according to some embodiments;

FIG. 17 shows a schematic diagram of an example client model and profile, according to some embodiments;

FIG. 18 shows a schematic diagram of an example client model and profile, according to some embodiments;

FIG. 19 shows a schematic diagram of an example client model and profile, according to some embodiments;

FIG. 20 shows a schematic diagram of an example client model and profile, according to some embodiments;

FIG. 21 shows a schematic diagram of an example client model and profile, according to some embodiments;

FIG. 22 shows a schematic diagram of an example client model and profile, according to some embodiments;

FIG. 23 shows a flowchart of an example method for identifying and addressing information security risks of an existing information systems, according to some embodiments;

FIG. 24 is a schematic diagram of example applications, according to some embodiments;

FIG. 25 is a schematic diagram of example visualizations for risk informed decisions, according to some embodiments; and

FIG. 26 is a schematic diagram of example interfaces with security services, according to some embodiments.

### DETAILED DESCRIPTION

The following descriptions of embodiments of the invention are exemplary, rather than limiting, and many variations and modifications are within the scope and spirit of the invention. Although numerous specific details are set forth in order to provide a thorough understanding of the present invention, it will be apparent to one of ordinary skill in the art, that embodiments of the invention may be practiced without these specific details. In other instances, well-known features have not been described in detail in order to avoid unnecessarily obscuring the present invention.

One or more embodiments of the invention are directed to an improved method and system for modeling and managing information security risks.

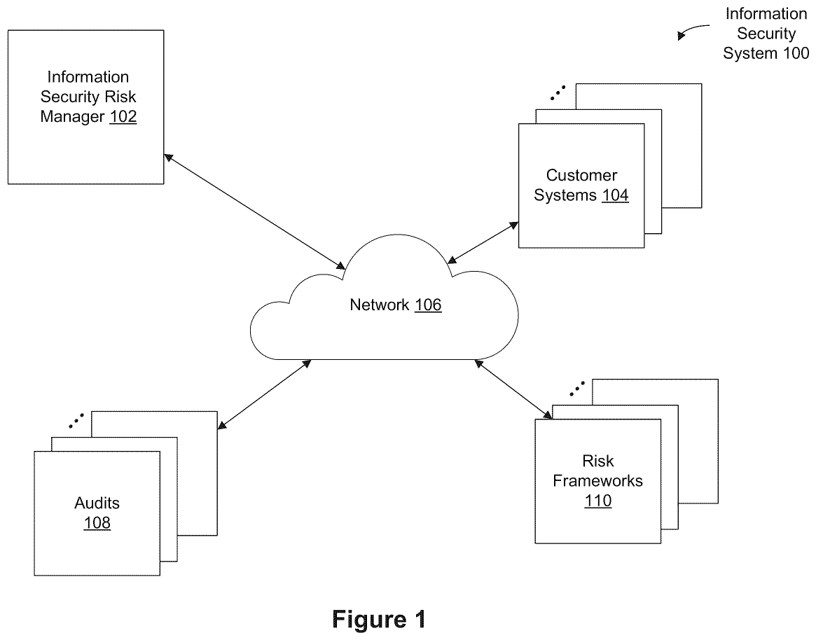

FIG. 1 is a schematic diagram of an example system 100 for modeling and managing information security risks, according to some embodiments. The system includes an information security risk manager 102 coupled to one or more customer systems 104 (sometimes referred to as computer systems or existing information systems), one or more risk frameworks 110, and/or one or more audits 108, via a network 106 (e.g., Internet).

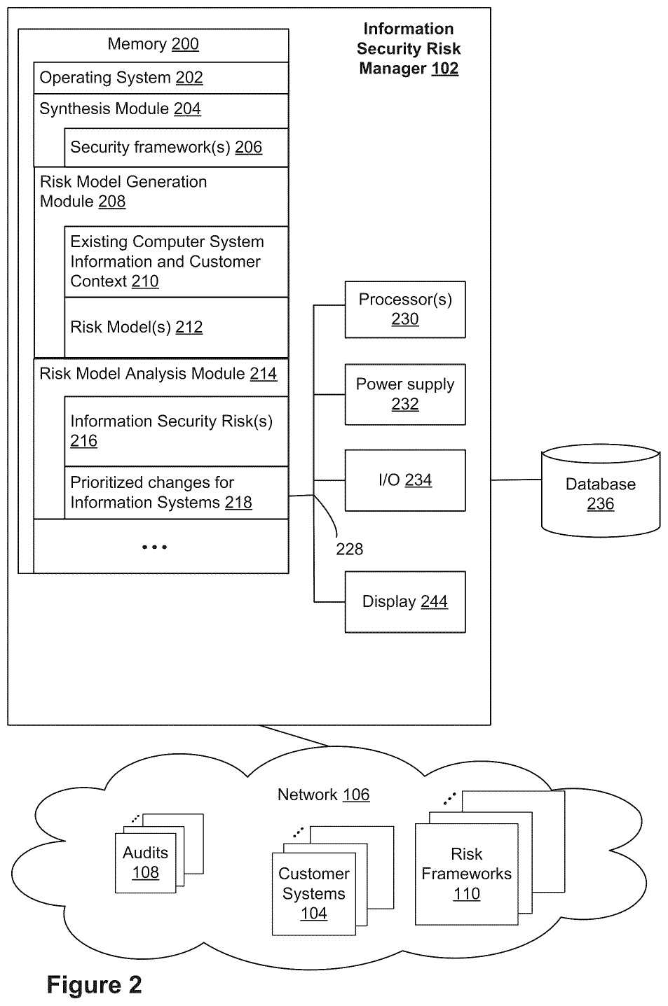

FIG. 2 is a system diagram of an example information security risk manager 102, according to some embodiments. The information security risk manager 102 typically includes one or more processor(s) 230, a memory 200, a power supply 232, an input/output (I/O) subsystem 234, and a communication bus 228 for interconnecting these components. Processor(s) 230 execute modules, programs and/or instructions stored in memory 200 and thereby perform processing operations, including the methods described herein according to some embodiments. In some embodiments, the information security risk manager 102 also includes a display 244 for displaying visualizations (e.g., risk scores, probabilities). In some embodiments, the information security risk manager 102 generates displays or visualizations, and transmits the visualization (e.g., as a visual specification) to a client device for display. Some embodiments of the information security risk manager 102 include touch, selection, or other I/O mechanisms coupled to the information security risk manager 102 via the I/O subsystem 234, to process input from users that select (or deselect) visual elements of a displayed visualization. In some embodiments, the client device (or software therein) processes user input and transmits a signal to the information security risk manager 102 for processing. Some aspects of the information security risk manager 102 (e.g., the modules in the memory 200) are implemented in one or more client devices, according to some embodiments.

In some embodiments, the memory 200 stores one or more programs (e.g., sets of instructions), and/or data structures, collectively referred to as “modules” herein. In some implementations, the memory 200, or the non-transitory computer readable storage medium of the memory 200, stores the following programs, modules, and data structures, or a subset or superset thereof:
an operating system 202;
a synthesis module 204 that synthesizes (or normalizes) security frameworks 206 to obtain normalized information security framework(s);
a risk model generation module 212 that generates risk models 212 (sometimes referred to as client models) based on existing computer system information and/or customer context 210); and/or
a risk model analysis module 214 that analyzed the risk models 212 to identify information security risks 216 and/or generate prioritized changes for information systems 218.

The above identified modules (e.g., data structures, and/or programs including sets of instructions) need not be implemented as separate software programs, procedures, or modules, and thus various subsets of these modules may be combined or otherwise re-arranged in various implementations. In some embodiments, memory 202 stores a subset of the modules identified above. In some embodiments, a database 236 (e.g., a local database and/or a remote database) stores one or more modules identified above and data associated with the modules. Furthermore, the memory 200 may store additional modules not described above. In some embodiments, the modules stored in memory 200, or a non-transitory computer readable storage medium of memory 200, provide instructions for implementing respective operations in the methods described below. In some embodiments, some or all of these modules may be implemented with specialized hardware circuits that subsume part or all of the module functionality. One or more of the above identified elements may be executed by the one or more of processor(s) 230.

I/O subsystem 234 communicatively couples server the information security risk manager 102 to one or more devices such as the audits 108, the risk frameworks 110, and/or the customer systems 104, via a local and/or wide area communications network 106 (e.g., the Internet) via a wired and/or wireless connection. In some embodiments, the audits 108, the risk frameworks 110, and/or the customer systems 104 push relevant information to the information security risk manager 102. In some embodiments, the information security risk manager 102 pulls relevant information from the audits 108, the risk frameworks 110, and/or the customer systems 104.

Communication bus 228 optionally includes circuitry (sometimes called a chipset) that interconnects and controls communications between system components.

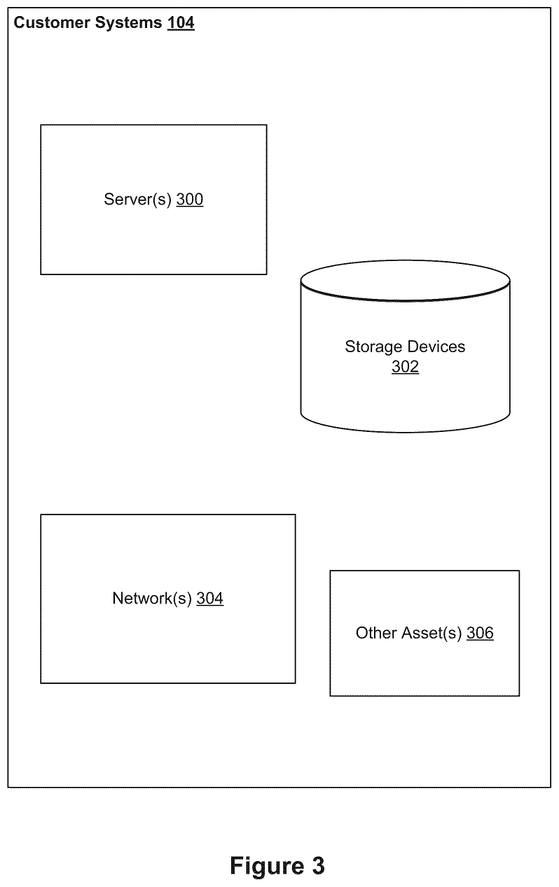

FIG. 3 is a block diagram of the customer systems 104, according to some embodiments. The customer system 104 includes one or more servers 300, one or more storage devices 302, one or more networks 304, and/or other assets 308 (e.g., physical systems, security devices, smart devices, including any Internet of Things or IoT devices). In various embodiments, these components are coupled together via one or more private or public networks.

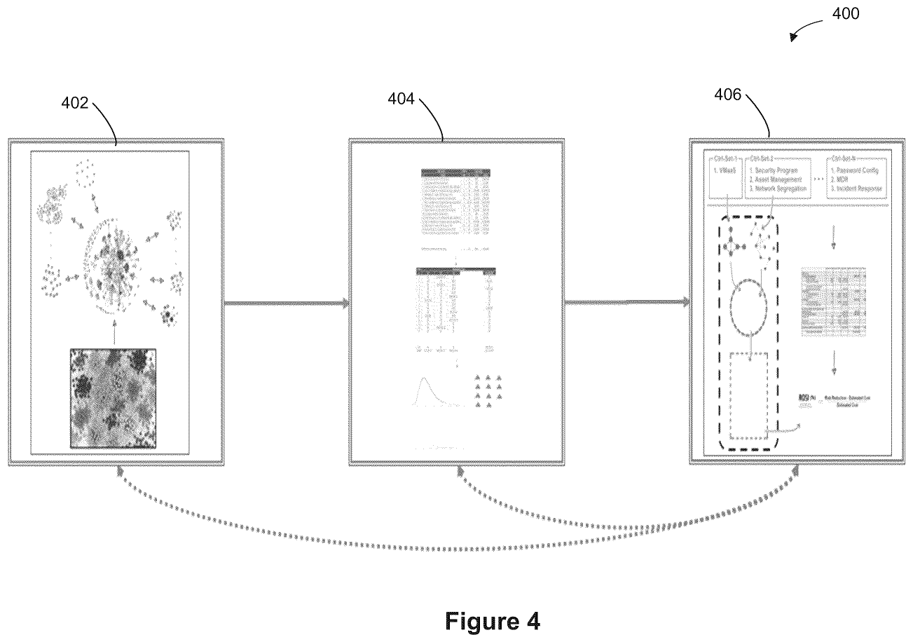

FIG. 4 is a schematic diagram of a system 400 for cybersecurity risk reduction, according to some embodiments. The system 400 includes an information security assessment system 402, a probabilistic risk engine 404, and a decision making system 406. The information security assessment system 402 defines and maintains an understanding of a client's business and information security context over time. The information security assessment system 402 helps capture a standardize and sharable representation of business context that is adaptable to a variety of methods, perspective, and evolutions. The probabilistic risk engine 404 manages, simulates and visualizes probabilistic risk. The probabilistic risk engine 404 helps probabilistically forecast real world business security risks expressed in financial terms (e.g., vocabulary amenable to top level decision makers). The decision-making system 406 empowers decision makers to strategically plan information security investments and initiatives. The decision-making system 406 helps generate control implementation recommendations and forecast their expected return on security investments (e.g., cost of control in relation to their forecast lost reduction). Referring to FIG. 2, in some embodiments, the information security assessment system 402 may be implemented using (or as part of) the synthesis module 204 and the risk model generation module 208. The probabilistic risk engine 404 and the decision-making system 406 may be implemented in the risk model analysis module 214.

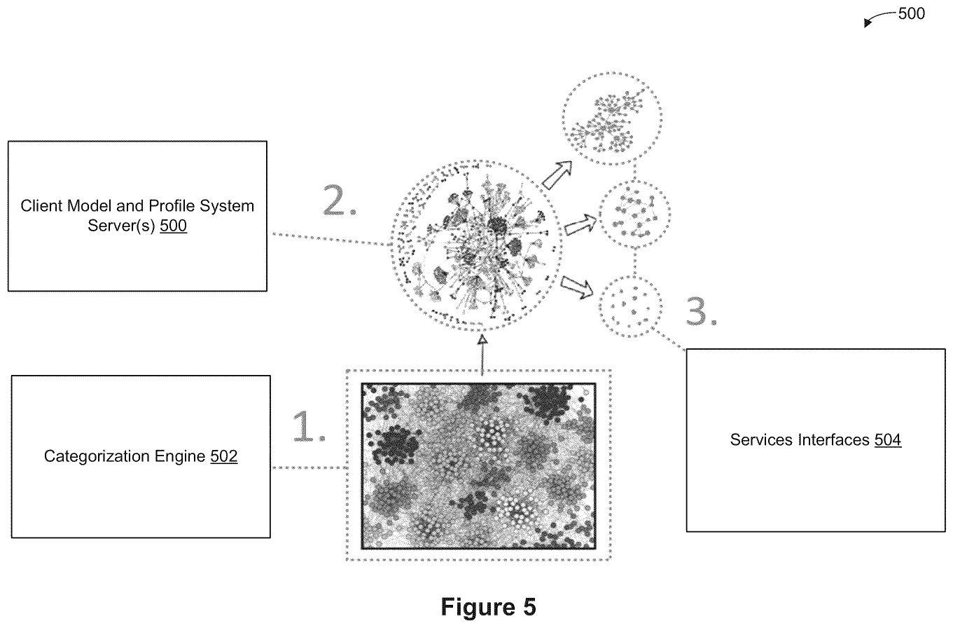

FIG. 5 is a schematic diagram of an information security assessment system 402, according to some embodiments. The system 402 includes a client model and profile system 500, a categorization engine 502, and services interfaces 504. The client model and profile system 500 stores client assessments that provides a representation of the client's context in the form of a flexible model and profile details (e.g., risk parameters). The model and profile details are constructed, elaborated, and maintained overtime. Details similar to those described above in reference to FIGS. 1 and 2 may be represented in a client model (sometimes referred to as a risk model) for an information system. The categorization engine 502 is a foundation for cyber security applications and includes libraries of categorizations and templates (e.g., “building blocks” and “blueprints”) that are flexibly managed. These libraries capture the representations of standards, assessments, and understandings. The services interfaces 504 are interfaces or windows to the client model. The interfaces scope sections of the model (e.g., breadth and depth), provide evaluation guidelines, and normalize correlated information. Services (e.g., advisory) interface with the client model and profile via the services interfaces 504.

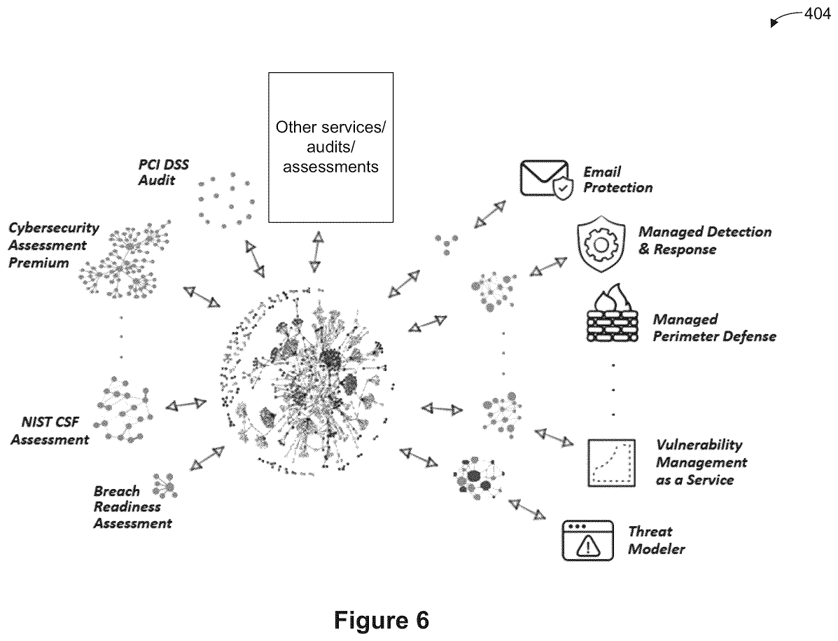

FIG. 6 is a schematic diagram of services interfaces 504, according to some embodiments. Services source from and feed into the client model and profile system 500 via the interfaces 504. The service interfaces 504 are the confluence of service scoping, evaluation parameters, and scoring normalization. Scoping templates parameterize what parts of the model are included in the service. Evaluation templates parameterize how to assess the scoped categories (e.g., scoring, granularity of analysis, sampling). Normalization provides the ability to translate equivalent evaluation results between disparate evaluation methodologies (e.g., between an ISO/IEC27001 audit vs a SOC2 Type 2 audit). Assessments and/or audits, such as PCI DSS audit, cybersecurity assessment, NIST CSF assessment, and breach readiness assessment, and security services, such as email protection, managed detection and response, managed perimeter defense, vulnerability management as a service, and threat modeler, may source from and provide input into the client model and profile, via the services interfaces 504.

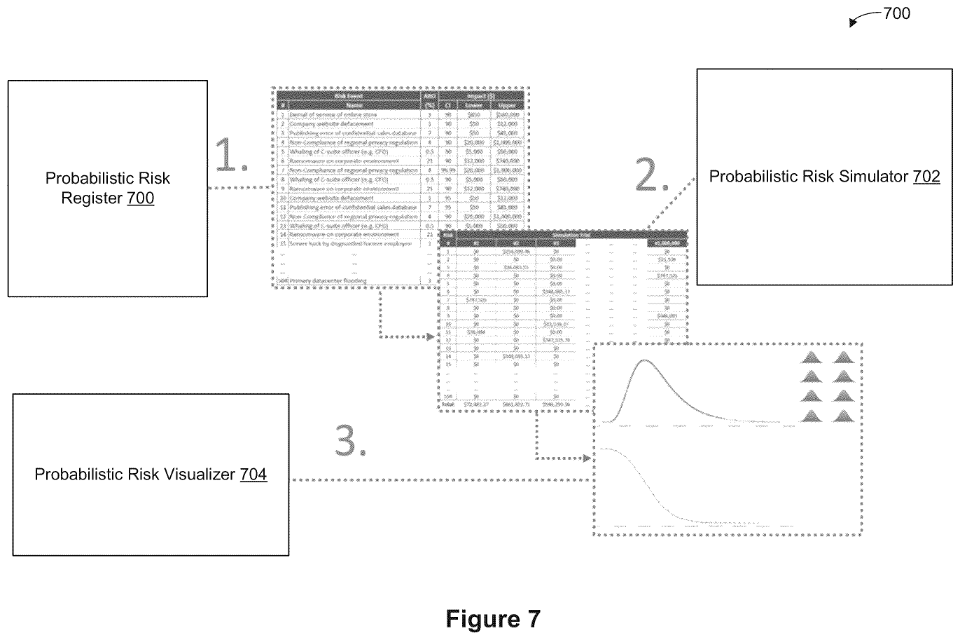

FIG. 7 is a schematic diagram of a probabilistic risk engine 404, according to some embodiments. The probabilistic risk engine 404 includes a probabilistic risk register 700, a probabilistic risk simulator 702, and a probabilistic risk visualizer 704. The probabilistic risk register 700 aggregates, manages, and filters lists of risk and their uncertain parameters, such as probabilities, duration ranges, and impact ranges. Risk entries can be generated from the scoped portions of the client model and profile. The probabilistic risk simulator 702 forecasts probabilities and financial impacts repeatedly simulated over a multiplicity of uncertain outcomes occurring across complex systems. Random outputs generated in simulations can be stored and reused towards standardizing control projection comparison. And the probabilistic risk visualizer 704 visualizes risk forecast in different representations, including comparison in relation to client risk tolerances. Visualization can also be presented on a per risk basis, or even per risk subset basis. Conventional risk approaches do not leverage probabilistic risk assessment (PRA) methods (despite these being well leveraged in other more mature industries). Further, some embodiments not only use PRA methods, but leverage them further beyond how PRA is used conventionally.

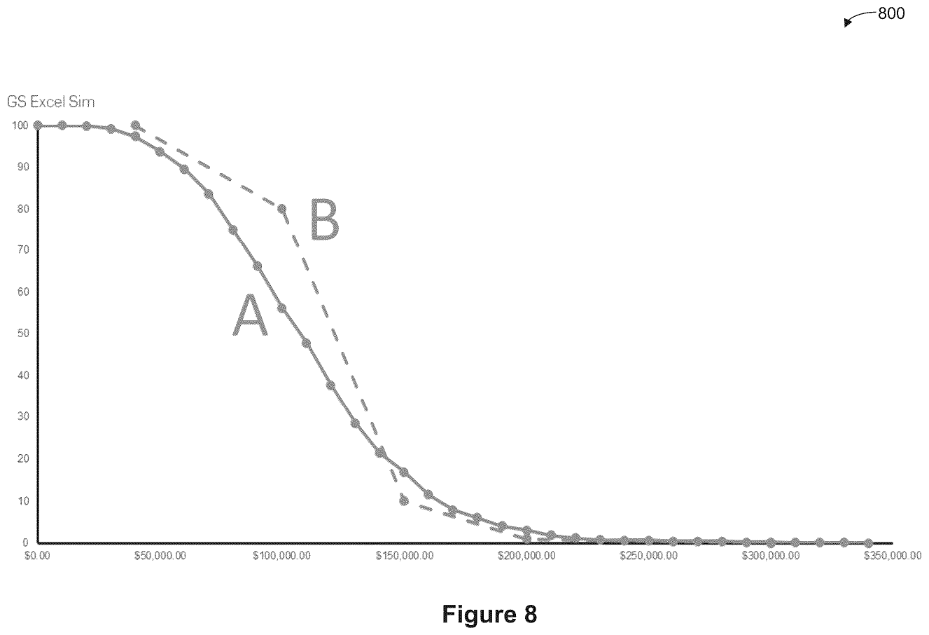

FIG. 8 is an example graphical visualization 800 generated by the probabilistic risk visualizer 704, according to some embodiments. Curve A corresponds to a risk curve that indicates the likelihood of certain losses occurring in a year. In this example, two sampled points include 90% chance of annual losses exceeding 60 k; and a 20% chance of annual losses exceeding 140 k. Curve A was generated from 888 trials in a proof-of-concept (POC) exercise; with more trials, a smoother representative line could be achieved.

Curve B corresponds to a risk tolerance line that is gathered from 5-data points from discussion with client top-management. The graph shows that the client is set to handle the more likely risk scenarios within their risk tolerance thresholds. However, the client is not well poised to handle the less likely risk scenarios which may occur (i.e., less than 20% more severe financial impacts). Curve B was generated by interpolating 5 story points to illustrate a comparison story (with respect to curve A). The story is summarized below (for illustration purposes):
suppose a client historically experiences and accepts $40,000-70,000 due to security incidences and outages yearly (translated as $40,000+ at 100%);
suppose further that the client can afford to lose $100,000 a year and maintain operations, but the client does not want to incur the loss all the time. Based on further client clarification, this requirement can be translated to maximum 80% chance a year acceptable;
$150,000 loss will start to hurt the client, but the client may accept risk as part of doing business, and may tolerate it as long as the loss is not frequent (e.g., at most once a decade (once a decade is ˜10% per year));
$200,000 will likely threaten the client's survivability in the immediate and it would take a significant amount of time to recover (after further discussion ˜1% per year); and
the client would likely not survive a loss of $300,000 or more in a year (never interpreted as 0%).

Some embodiments may use the categorization engine 502 to perform the above analysis or summarize at multiple levels (e.g. per company division, department). If the company has a risk acceptance criteria defined (that is not simply just a scalar), then some embodiments may use that instead of risk tolerance discussion session with management.

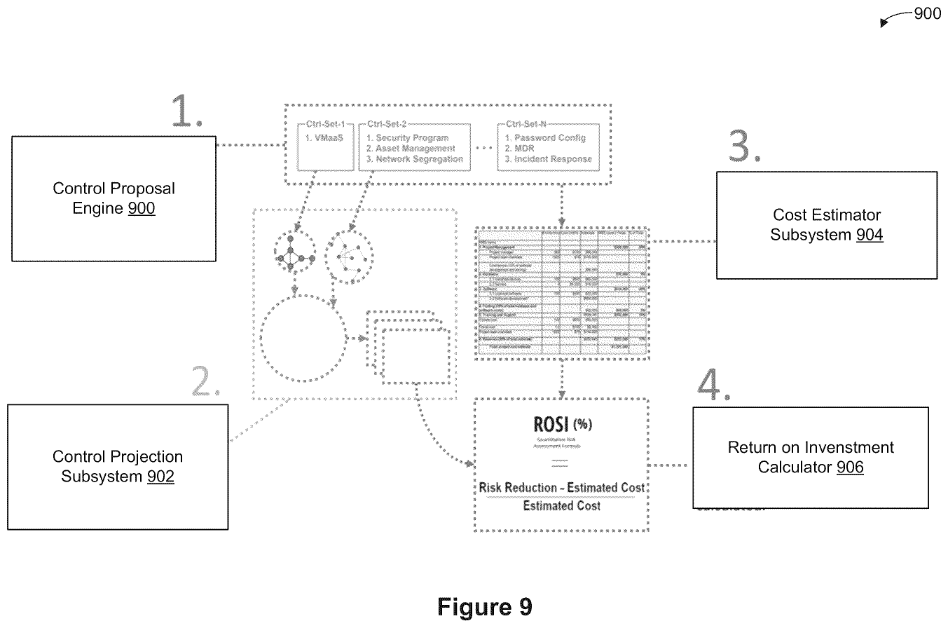

FIG. 9 is a schematic diagram of a decision making system 406, according to some embodiments. The decision making system 406 includes a control proposal engine system 900 to identify and propose controls that are correlated to significant risks. For example, a control set 1 may include VMaaS, a control set 2 may include security program, asset management and network segregation, and a control set N may include password configuration, MDR and incident response, and so on. The decision making system 406 also includes a control projection subsystem 902 whereby control sets can be projected into the client model and profile and run through the probabilistic risk engine to forecast risk given control sets. The decision making system 406 includes a cost estimator subsystem 904 for estimating and entering expenditures (e.g. CAPEX and OPEX). The decision making system 406 also includes a return on investment calculator 906 whereby based on control projections and cost estimations, various forms on return on investments can be calculated.

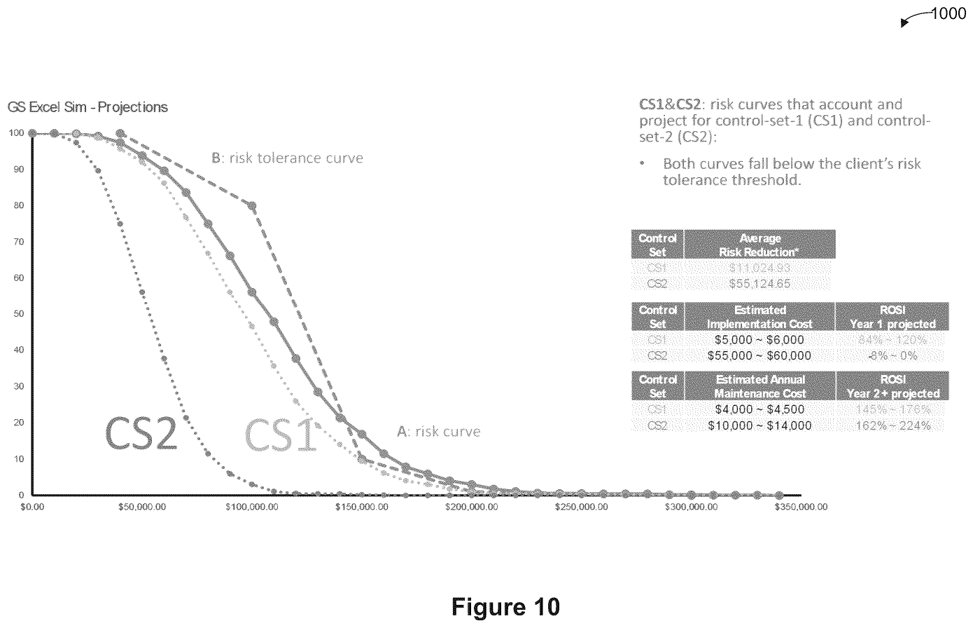

FIG. 10 is an example graphical representation 1000 for control-adjusted risk projection (sometimes referred to as control projection) and ROSI for two sets of proposed controls, according to some embodiments. Curves CS1 and CS2 are risk curves that account and project for control set 1 and control set 2, respectively. Both curves fall below the client's risk tolerance threshold. Curve A corresponds to risk curve and curve B corresponds to risk tolerance curve. Not all solutions proposed necessarily must change the risk curve; it is possible to have a same risk curve and still have a better return on investment due to cost factors. For example, average annual loss expectancy (ALE) may drop original risk curve (of $110,249.30) by $11,024.93 for C1 and $55,124.65 for C2. Instead of average drop, some embodiments use ranges on a distribution, which has additional benefits like better accounting for likelihood spreads, for example. If there is no overlap between C1 and C2, a combination of the two may be proposed along with an indication of what the aggregate would result into.

Estimated cost of implementation (CAPEX) may be provided as follows: C1: 5 k to 6 k and C2: 55 k to 60 k. Estimated cost of implementation (OPEX) may be provided as C1: 4 k to 4.5 k and C2: 17 k to 21 k. Typically, first years include a mix of CAPEX and OPEX, but for simplicity suppose CAPEX applies for year-1 and OPEX applies for each consecutive year. ROSI may be calculated as (risk reduction-control cost)/control cost. CAPEX ROSI: C1_lower_cost: (11,024.93−5,000)/5,000=1.20=>120%; C1_upper_cost: (11,024.93−6,000)/6,000=0.84=>84%; C2_upper_cost: (55,124.65−60,000)/60,000=−0.08=>−8%. OPEX ROSI may be provided as C1_lower_cost: (11,024.93−4,000)/4,000=1.76=>176%; C1_upper_cost: (11,024.93−4,500)/4,500=1.45=>145%; C2_lower_cost: (55,124.65−17,000)/17,000=2.24=>224%; C2_upper_cost: (55,124.65−21,000)/21,000=1.62=>162%. Other aspects that may be accounted for could include things like amortized cost of implementation, etc. ROSI may be represented not only as a range, but further as a distribution (including if the risk reduction is represented on a distribution). Note that the above projects are all predicated on projection of controls improvements, but other types of projects could also be possible. For example, (i) control regression projections (e.g. in the absence of an effective security program in place)—assumptions may be clarified to clients; (ii) anticipated worsening types threats (e.g., ransomware expected to double in the next year—what the impact could be on the current environment); (iii) variable business impacts (e.g. an outage of the online storefront during the Christmas season is more impactful than other times of the year).

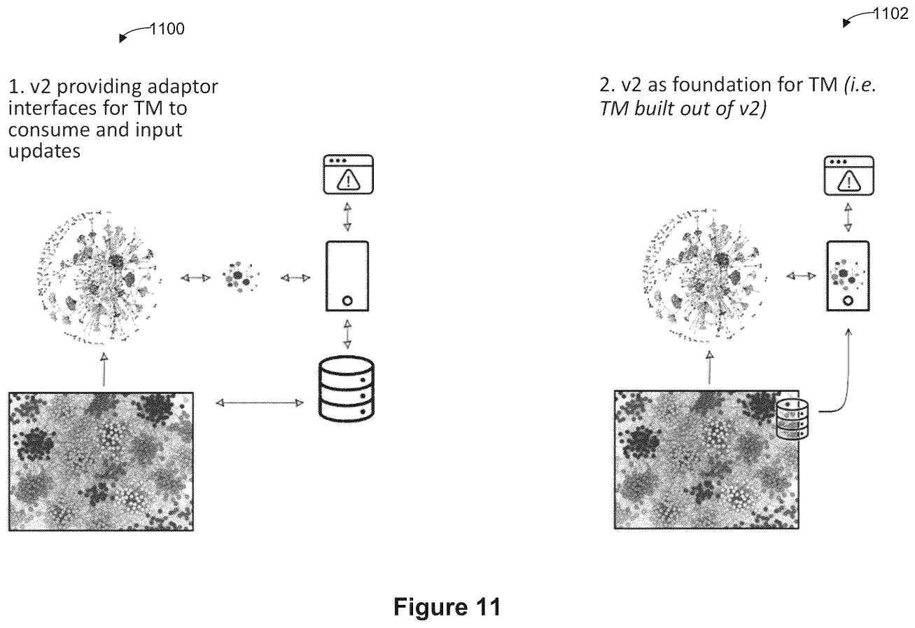

FIG. 11 is a schematic diagram of example interfaces to a threat modeler, according to some embodiments. The system may provide adaptor interfaces 1100 for a threat modeler to consume and input updates. Alternatively, the system may serve as a foundation 1102 for a threat modeler.

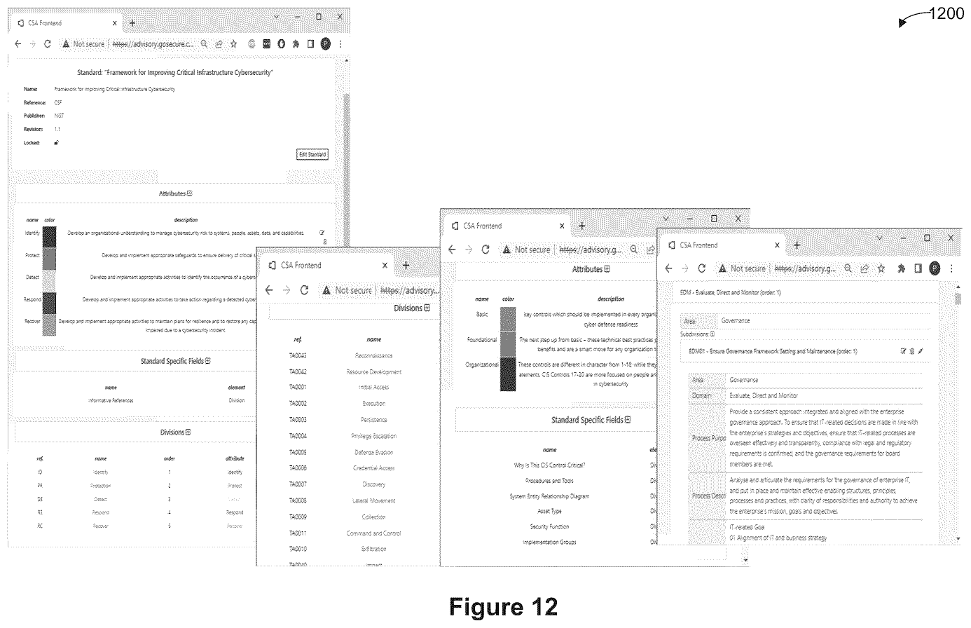

FIG. 12 shows example screenshots 1200 for entry of standards and frameworks, according to some embodiments. Categorization engine provides an agnostic system that allows for the entry of standards and frameworks on their own terms (with their particularities). The sample screenshots correspond to NIST CSF v1.1, MITRE ATT&CK Enterprise, CIS Controls v7.1, and ISACA COBIT 5.

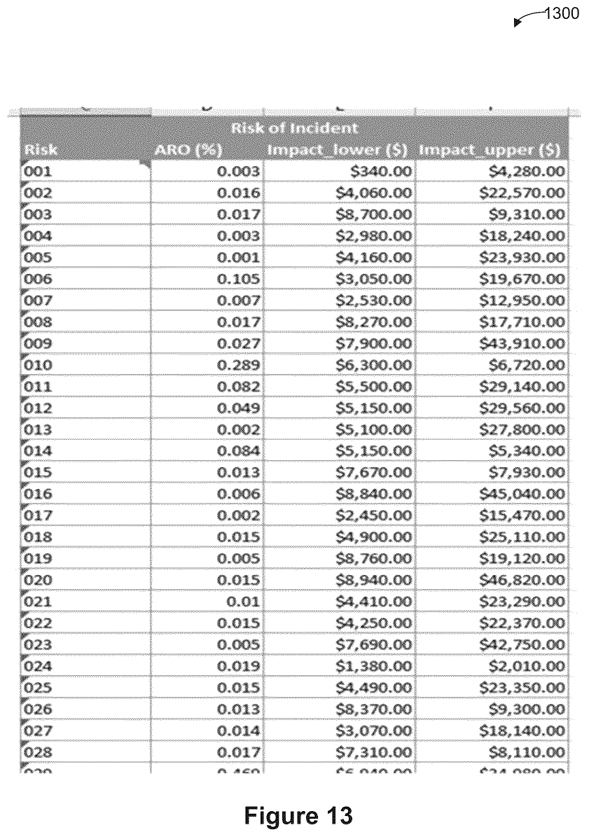

FIG. 13 shows a table 1300 for an example probabilistic risk register, according to some embodiments. The example shows simplified probabilistic inputs (e.g. simplified single annual rate occurrence (ARO), simplified fixed impact range; more nuanced probabilistic inputs are possible). The extract shows 28 of 200 input Excel entries. Numbers used to populate sample in the example are semi-random; in some embodiments, the system may use curated data templates.

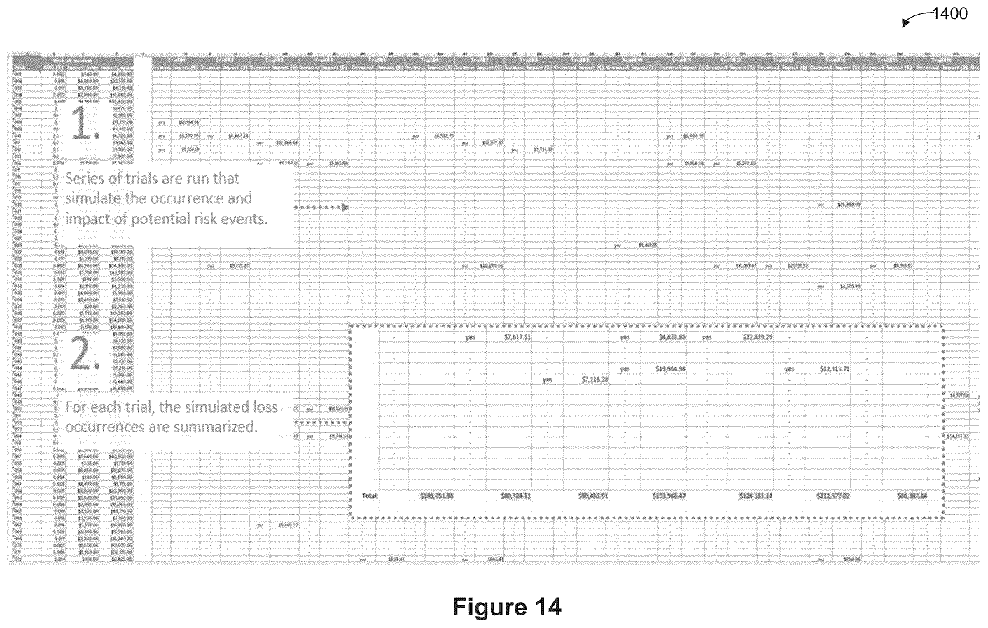

FIG. 14 shows a table 1400 of example results from a probabilistic risk simulator, according to some embodiments. The example shows results for 16 trials. Series of trials were run that simulated the occurrence and impact of potential risk events. For each trial, the simulated loss occurrences are summarized.

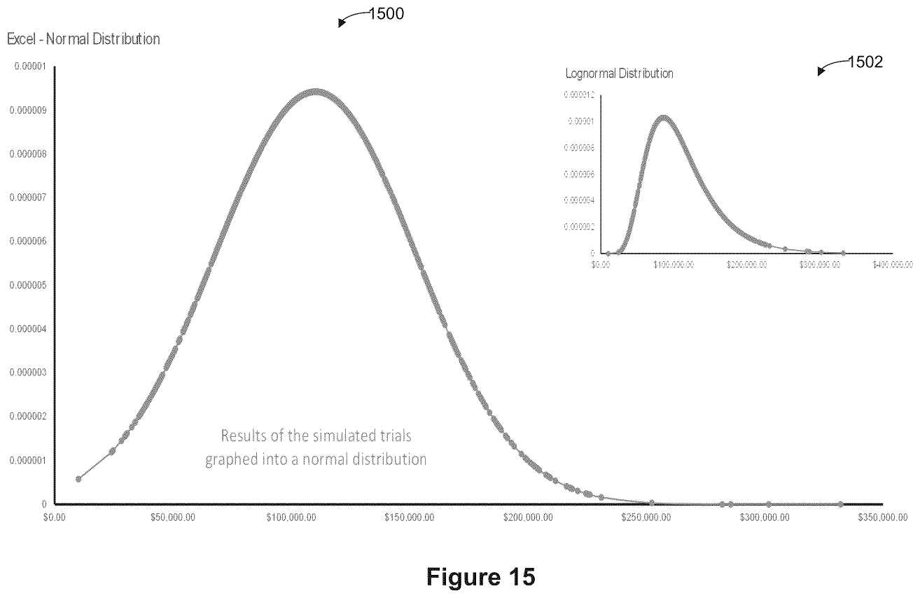

FIG. 15 shows example graph plots output by the probabilistic risk visualizer 704, according to some embodiments. The examples correspond to distributions based on 888 simulated trials. The graph plot 1502 shows results of the simulated trials graphed into a normal distribution, and the graph plot 1504 shows results of the simulated trials graphed into a lognormal distribution.

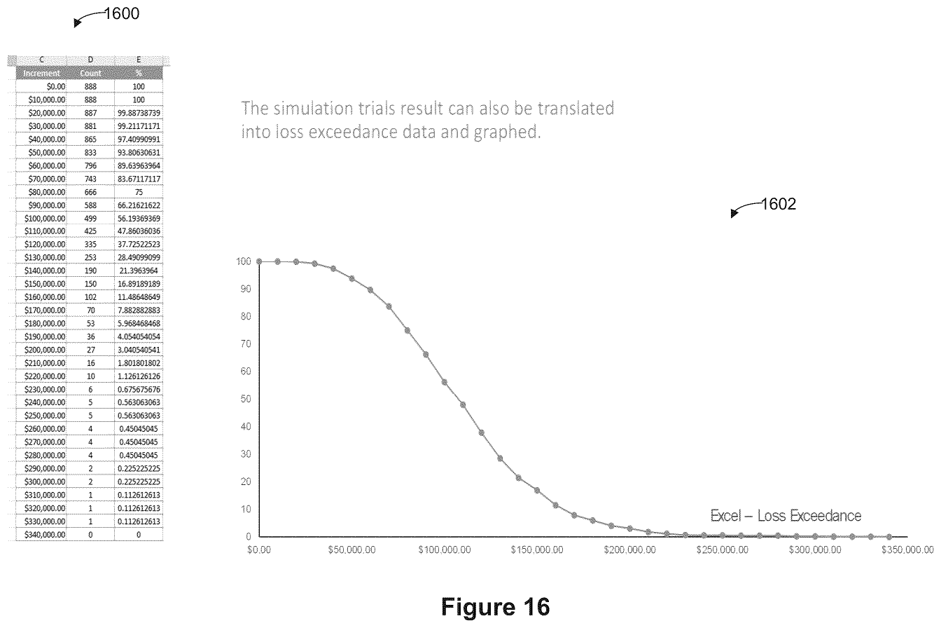

FIG. 16 shows example visualization for loss exceedance, according to some embodiments. Simulation trials result 1600 can be translated into loss exceedance data and graphed 1602.

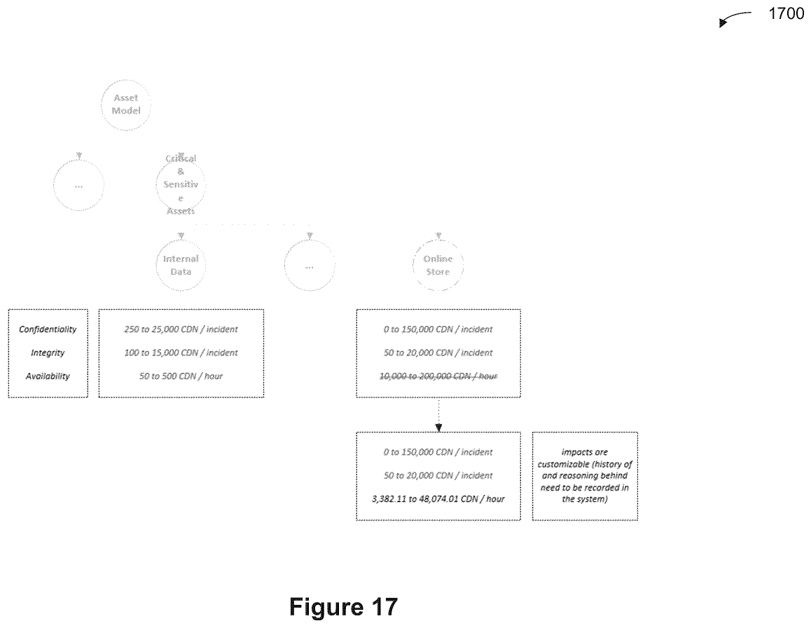

FIG. 17 shows a schematic diagram of an example client model and profile 1700, according to some embodiments. The example shows a risk model with templated risk profile impact parameters. Risk profile parameters data can be templated. The example shows generic risk-profile impact-parameters per type of information security categorization. Risk profile parameter can be customized per client context. Risk-profile impact-parameter ranges can be handled like a distribution.

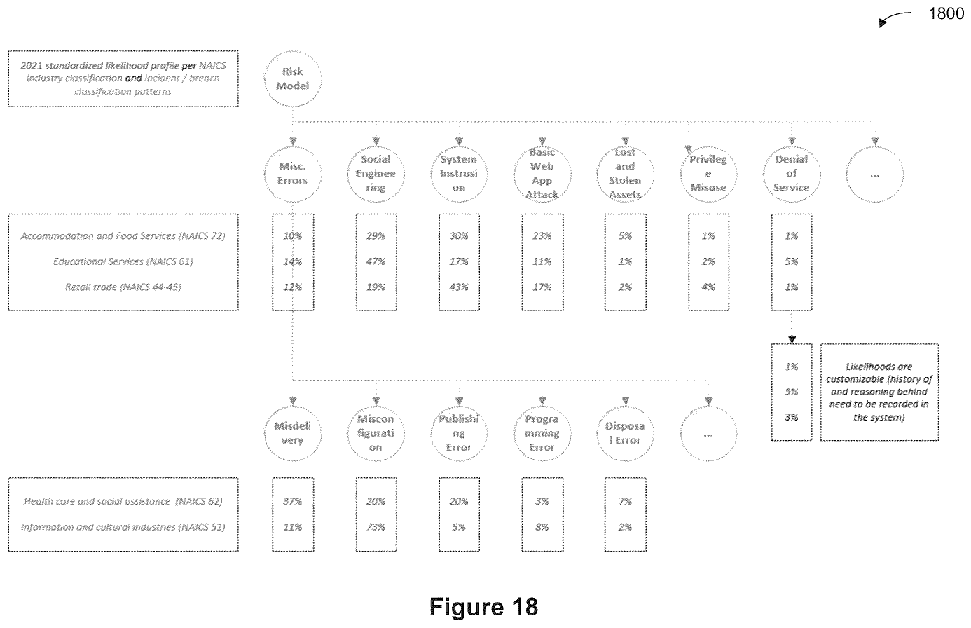

FIG. 18 shows a schematic diagram of an example client model and profile 1800, according to some embodiments. The example shows a risk model with templated risk profile likelihood parameters. Risk profile parameters data can be templated. The example shows generic risk-profile likelihood-parameters per risk-categorization and per NAICS categorization. Risk profile parameter can be customized per client context. Risk-profile likelihood-parameter data can be nuanced into ranges to reflect additional factors like controls in place.

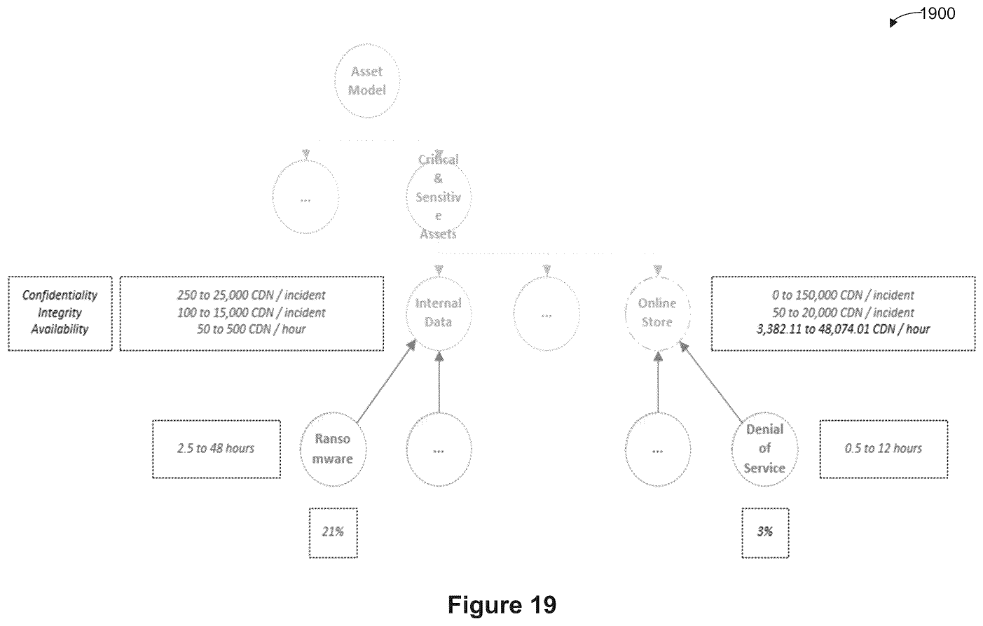

FIG. 19 shows a schematic diagram of an example client model and profile 1900, according to some embodiments. The example shows network effect-risk events from asset and risk categorization relationships. Relationships between modelled asset and risk categorizations can be leveraged to autogenerate risk events. For example, “Ransomware of Internal Data” risk event has a 21% likelihood of a potential confidentiality impact range of $250 to $25,000 Canadian. As another example, “Denial of Service of Online Store” risk event has a 3% likelihood of a potential availability impact of $1,691.06 to $576,888.12 Canadian. Risk categorizations can be related to multiple asset categorizations. These examples are simplified to ignore nuances of distribution between C, I, A, and permutations thereof.

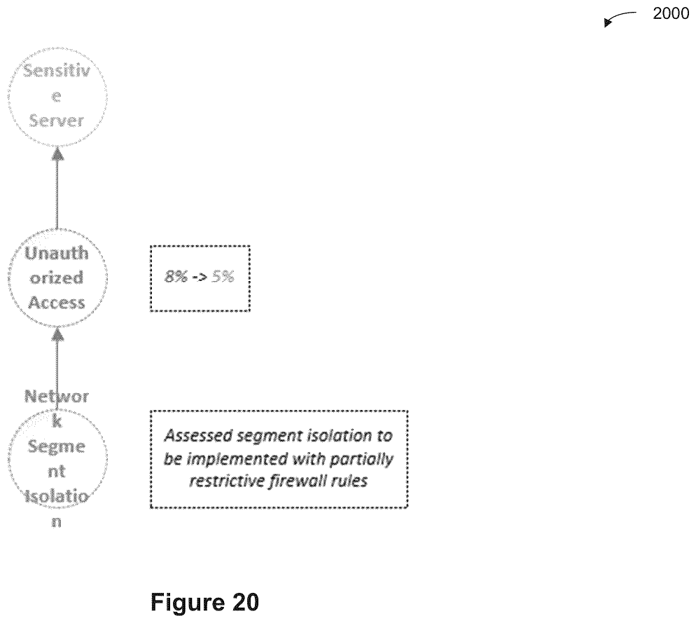

FIG. 20 shows a schematic diagram of an example client model and profile 2000, according to some embodiments. The example shows risk-profile parameter adjustment according to related controls. The example shows generic risk-profile likelihood-parameter being decreased based on quality of related control. Other risk-profile parameters can also be adjusted; e.g., impact-parameters can be mitigated by insurance coverage and event duration-parameters can be mitigated by incident response.

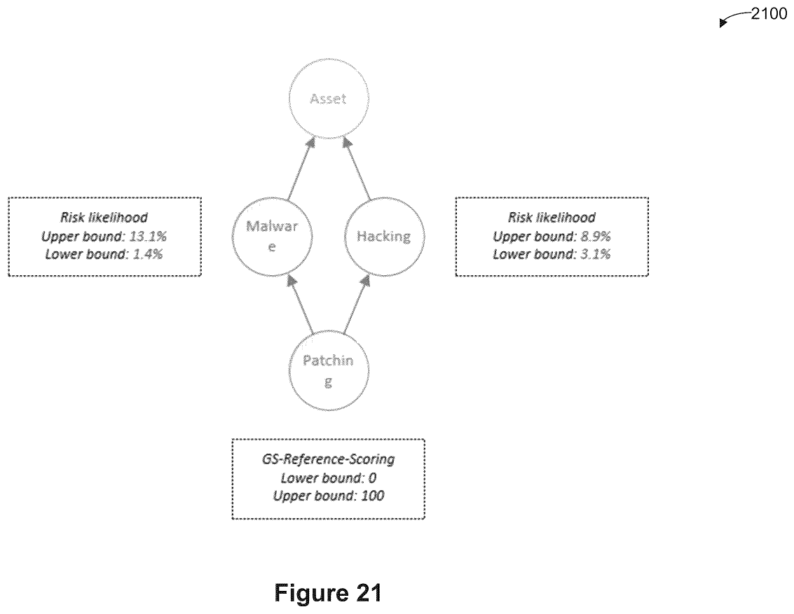

FIG. 21 shows a schematic diagram of an example client model and profile 2100, according to some embodiments. The example shows network effect-control categorizations can adjust multiple risk categorizations. A single control categorization can adjust multiple risk categorization. In this example, scoring the patching categorization will individually adjust risk-profile likelihood-parameters for each the malware and hacking categorizations.

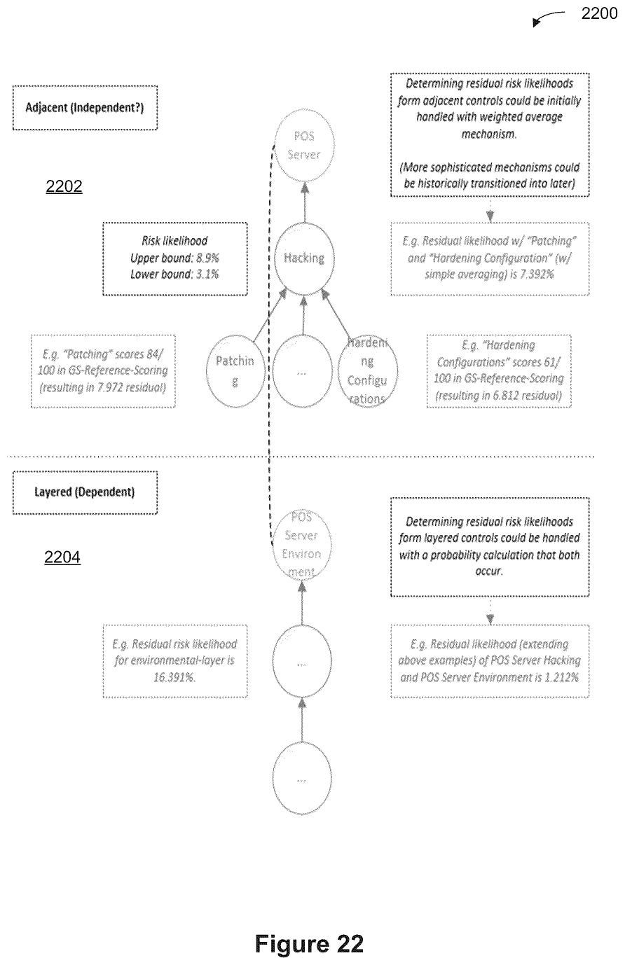

FIG. 22 shows a schematic diagram of an example client model and profile 2200, according to some embodiments. The example shows network effect due to multiple and/or layered control categorizations. Multiple control categorization can adjust a single risk categorization. In the example 2202, scoring the patching-to-configuration categorizations will adjust risk-profile likelihood-parameters for the hacking categorization. Layered control categorizations can significantly adjust risk categorizations (i.e., depths-in-depth). In the aggregate-example 2204, scoring the POS environment, in which the POS Server is hosted, will further adjust risk-profile likelihood-parameters for the hacking categorization.

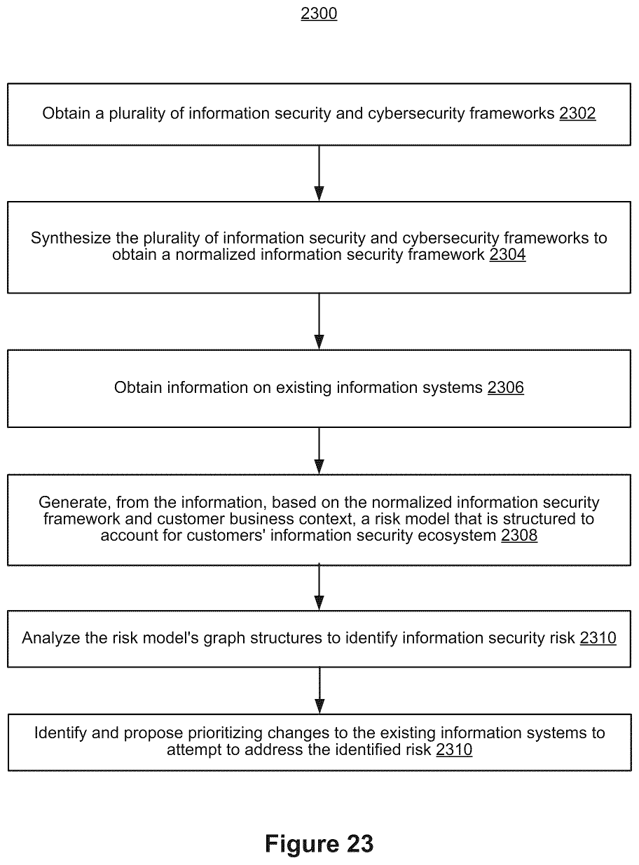

FIG. 23 shows a flowchart of an example method 2300 for identifying and addressing information security risks of an existing information systems, according to some embodiments. The method is performed by the information security risk manager 102. The method includes obtaining (2302) (e.g., by the synthesis module 204, from the audits 108 and/or risk frameworks 110) a plurality of information security and cybersecurity frameworks (e.g., the security frameworks 206). The method also includes synthesizing (2304) (e.g., by the synthesis module 204) the plurality of information security and cybersecurity frameworks (e.g., consolidating, integrating and/or aligning the frameworks for deriving an agnostic normalized reference framework; ingesting these frameworks into a normalized data format) to obtain a normalized information security framework. The method also includes obtaining (2306) (e.g., by the risk model generation module 208) information on existing information systems (e.g., the information and/or business context 210). The method also includes generating (2308), from the information, based on the normalized information security framework, and customer business context, a risk model (e.g., the risk model 212) that is structured to account for customers' information security ecosystem. In some embodiments, the model's structure and content includes multipartite graphs for existing information systems. Besides the information, information processes and information processing systems, such as computer systems, examples of the information security ecosystem include, other information security considerations, such as the regulatory, legal and compliance environment within which the customer maybe operating within. The method also includes analyzing (2310) (e.g., by the risk model analysis module 214) the risk model's graph structures to identify information security risk (including cybersecurity risk; e.g., the information security risks 216). The method also includes identifying and proposing (2312) prioritizing changes (e.g., the changes 218) to the existing information systems (including computer systems) to address the identified risk.

In some embodiments, each information security and cybersecurity framework can include a taxonomy of risks, controls and/or assets.

In some embodiments, synthesizing the plurality of information security and cybersecurity frameworks uses predetermined libraries of categorizations and templates. Categorizations and/or templates include building blocks and blueprints that can be flexibly managed. These libraries capture the representations of standards, assessments, and understandings.

In some embodiments, the normalizing comprises addressing biases and variability across the plurality of information security and cybersecurity frameworks.

In some embodiments, the client model includes nodes representing risks, controls and/or assets, and edges representing relationships between the nodes.

In some embodiments, analyzing the risk model's graph structures includes traversing the risk model's graph structures to identify risk entries for risk simulations, and populating information in the risk entries at least in part from a risk profile associated with the existing information systems.

In some embodiments, the risk profile is customizable by an operator of the existing information systems.

In some embodiments, the risk profile includes templated risk-profile likelihood parameters per risk categorization and per NAICS categorization. The risk-profile likelihood parameters are customizable per client context, and wherein data for the risk-profile likelihood parameters includes ranges for controls. Some embodiments represent risk in terms of a few parameters including “likelihood.” Risk may be defined with “likelihood” and “impact” and may include additional details. In terms of “likelihood” there are many ways to represent it (i.e., several qualitative and quantitative). To quantify “likelihood” to resemble real world observed occurrences, some embodiments use known sources, such as the data from the annual DBIR reports (which happen to organize data per the NAICS classifications, available at https://www.census.gov/naics/). Some embodiments categorize content based on the NIACS. Categorization system may not be limited to use NIACS alone. Since risk may not be identical from one client/customer to the next, some embodiments contextualize and/or customize risks to specific clients. There are several ways of doing this. In some cases, each client operates within at least one industry, so some embodiments begin with the DBIR&NIACS data to create baseline risk profiles as a starting point. Different clients may have different controls implemented. Accordingly, some embodiments analyze the quality of controls to further adjust and/or customize data of the risk profiles. Some embodiments take into account asset value. In some embodiments, the data within the categorization systems and in the risk profiles are not dependent or only constrained to particular frameworks or data sources (e.g., DBIR and NIACS data). But because there are openly available data, some embodiments are initially based on these sources and are designed to accommodate other sources. In other words, the systems will be flexible enough to (concurrently) use other useful sources.

In some embodiments, a client's information security business context is represented on a client model (which may include multipartite graphs within it). The client model may be populated with risk profile information (including statistical information) associated with its existing information systems, and used for statistical analysis of risk.

In some embodiments, the statistical analysis includes identifying one or more control sets that are most correlated to most significant risks, projecting the one or more control sets into a copy of the current client model, and forecasting risk adjusted by one or more control sets by reapplying the risk methods used to generate the risk forecast of the current client model.

In some embodiments, identifying the one or more control sets that are most correlated to most significant risks includes setting up pre-simulation. The client model is defined in which we will have the relations between the significant categories representing assets, risk and controls. Each of these categories will be profile with their relevant risk data. Typically, an assessment of the quality of controls in scope is performed already. In some embodiments, identifying the one or more control sets also includes risk simulation and/or obtaining results. The risk entries used as inputs (to the risk simulations) is calibrated according to the quality/design of their associated controls. The client model has the relations between the control categories and risk categories as part of its definition. A set of risk results is output by the risk simulation. In some embodiments, identifying the one or more control sets also includes post-risk simulation. There are a number of ways to perform post-risk simulation. The following example is provided for illustration purposes. From the data, some embodiments identify the greatest risk losses to the risks entries originating them. From the identified risk entries, some embodiments identify the risk and controls related to them (or lack of controls). From the controls associated to them, some embodiments triage the controls that scored badly in quality in relation to other controls. Overall, this would help identify and sort-through the controls (or lack of) that are more strongly correlated.

In some embodiments, projecting the one or more control sets into the client model includes using a list of controls (identified as described above) to propose single controls or propose sets of controls for implementation or improvement. For the projection, some embodiments create new instances of the client model from which to test “What-If” scenarios. Each scenario starts from the instance but replaces the current control environment with the proposed improved/implemented controls.

In some embodiments, forecasting risk for the one or more control sets using one or more probabilistic risk assessment includes, for each projection created (i.e. for each “What-If”), generating new risk entries as inputs for a new risk-simulation. The output risk results are the forecast of the scenario sporting the improved/implemented controls. These results can be used by the client to compare the forecasted risk with the “What-If” controls against their current state results.

In some embodiments, the statistical analysis includes generating risks from scoped portions of the client model (which in part may include multipartite graphs), and aggregating, managing, and/or filtering lists of risks and their uncertain parameters, such as probabilities, duration ranges, and impact ranges. Scoping templates parameterize what parts of the model are included in the service. The scope portion defines what portion of client model will be handled or assessed, for each mandate (e.g., individual agreed projects for a client). Examples for scoping and scoping templates are described herein. A client model can be very large. Clients do not always need to assess all their environment in depth (or may not have the budget to do so). A goal of scoping is to isolate the breadth of a project (e.g., which assets/risks/controls/etc. categories) and depth of analysis (e.g., high-level conversation with client for information gather to low-level nitty-gritty configuration analysis, etc.) to those agreed upon with the client. For example, if a client just wants to tackle the risk around their on-premise wireless network, then there is no need to dive deep into their entire cloud environment. The scoping templates capture reoccurring scopes into reusable and/or repeatable form (instead of having to comply select categories in scope from scratch with every new mandate). For example, standard cybersecurity assessment that have broad but moderate depth scopes can be partially templated in one way, while an incident readiness assessment which is narrow but deep can be templated another way.

In some embodiments, the statistical analysis includes forecasting probabilities and financial impacts by repeatedly simulating over a multiplicity of uncertain outcomes occurring across complex systems. Some embodiments use Monte Carlo simulations. The input and how the outputs are leveraged afterwards may be different from conventional simulations. The number of iterations for the simulation may depend on computational power available, but a goal may be to achieve a predetermined precision level while leveraging the law of large numbers and to better capture representations of rare occurrences. Multiplicity of uncertain outcomes is due to complex information systems and environments. Often when dealing with complex systems with lots of variables (including variables with unknown quantities), the system ends up having to solve problems with a lot of uncertainty. So ‘multiplicity of uncertainty’ means that there are lots of uncertain variables that multiply in number as the complexity of a system assessed increases. The systems can be complex for assessing risk because the system includes the client's business context and environment along with its information systems (e.g., systems composed of information, processes, people, hardware, software, networks, governance structures) along with its ecosystem (e.g., regulations). In some embodiments, the system is designed to flexibly adapt to client information security context which are complex systems themselves. There is typically a lot of uncertainty around which there is limited control over. Monte Carlo Simulations are well suited for these situations.

In some embodiments, the statistical analysis includes storing and reusing random outputs generated in simulations towards standardizing control projection comparison. Simulations are typically Monte Carlo Simulation whereby large swaths of random numbers are generated and compared against the various input and input parameters. The inputs are generated risk entries and how these entries are defined. Typically, random numbers are generated from true random number generators or pseudo random number generators. In the first case, each rerun is expected to produce new sets of random numbers. In the second case, the number output is expected to be repeatable. Some embodiments execute “what-if” scenarios. Reusing a large set of number outputs could yield more comparable results between “What-If” scenarios versus the current of controls state forecast (at least for a smaller set of repeats). Some embodiments store random numbers generated using “true” random generation of numbers and reuse the numbers with the “What-If” scenarios.

In some embodiments, the statistical analysis includes performing a series of trials that simulates occurrence and impact of potential risk events, and for each trial, summarizing simulated loss occurrences.

In some embodiments, the information on the existing information systems (which includes information on a computer system) is updated and/or obtained from one or more compliance audits or assessments of security risks for the existing information systems.

In some embodiments, the risk profile does not capture the risk distribution, but it is used in the generation of risk entries used as inputs to the risk simulations. From the risk simulations' output, some embodiments aggregate results to show the distribution of risk impacts. Related to risk distribution, it is possible to take the entirety of the risk simulation outputs to graph a risk distribution of its impacts (i.e., what is the forecast for the entirety of the scope we are assessing). It is also possible to filter subsets of the results to refine understanding of these risks (e.g., what does the distribution look like for the risks associated with asset A or risks associated with control group B or risks associated with security category C).

In some embodiments, the results of a risk assessment is reorganized per predefined categories, including predefined security categories or categories defined within the client model.

In some embodiments, the method further includes autogenerating risk events based on relationships between modelled asset and risk categorizations. The risk categorizations are related to one or more asset categorizations. Some embodiments create or generate risk entries from a client model (instead of manually populating risk entries individually and all their parameters). For example, in a client's model, as part of the assessment process, categories of assets (e.g., critical/sensitive information, processes, supporting assets, and security capabilities) that are in scope are identified. Categories of risks (e.g., social engineering, basic web app attacks) that are in scope are also identified. Threat sources considered for (e.g., external, internal threats) that is relevant to the client context are also identified. Some embodiments obtain, from a client, different risk relevant profiling information (e.g., $ impact of an online store asset going down for a duration, % likelihood of an educational institution being hit by a denial of service incident). Some embodiments assess the quality of controls in place and how they adjust impacts/likelihoods/etc. From the client model and its profiling data, some embodiments automate the traversal the scope of the client model to identify the risk entries to automate their generation on a case-by-case basis. Some embodiments update the client model to capture the relations between the categories of assets, risks and controls at play.

In some embodiments, the method further includes adjusting a plurality of risk categorizations based on a single control categorization. For example, the client model has the relation specified between the controls in place and the risks at play. One security control may help address a number of risks (e.g., “security awareness, education and training” can help mitigate both the risk of “Social Engineering” and “Misc. Errors”, a well configured/maintained cluster of firewalls may help reduce the particular likelihood of incident/breaches for a number of systems within the network, and so on). Therefore, if one control is tied to a number of risks, and that control is greatly improved, then the risk factor for the risks associated with that control would diminish.

In some embodiments, the method further includes adjusting a single risk categorization based on a plurality of control categorizations, including handling residual risk likelihoods from adjacent controls using a weighted average mechanism. Some embodiments define how to adjust risk profile information when assessing controls that are independent from the other adjacent. For example, risk of unauthorized access of a server room can be done through the main door, through the wall, through the air ducts; accessing one is not dependent on accessing the other. Weighting is useful because not all options are equally likely. For example, an unauthorized person is more likely to use the front door than try the airducts. The dependent or adjacent controls can be identified from how the relations are defined between the categories within the client model.

In some embodiments, the method further includes adjusting risk categorizations based on layered control categorizations, including handling residual risk likelihoods from layered controls using a probability calculation that both controls occur. Risk profile information may be adjusted when assessing controls that are dependent on the other controls layered in front of it. For example, the aforementioned server room maybe located in a secured section of the building, and the building maybe surrounded by a guarded perimeter. So to try to get through the server room protections, an external actor would need to first get through the first layer. In this case, some embodiments calculate the probability of unauthorized access server room given the probability of access to the secure location and given the probability of getting past the perimeter. The independent or layered controls maybe identified from how the relations defined between the categories within the client model.

In some embodiments, the method further includes adjusting one or more risk-profile parameters according to related controls, including decreasing generic risk-profile likelihood parameters based on quality of related control, mitigating impact parameters by insurance coverage, and mitigating event duration parameters by incident response. Examples for how risk profiles can be adjusted include lowering likelihood, duration and/or impact of a risk event occurring.

In some embodiments, the method further includes providing interfaces to the client model and an associated risk profile. In some embodiments, this step includes scoping sections of the client model and the associated risk profile (e.g., identifying risks/controls/assets for the service and corresponding risk profile). Scoping refers to the risks/controls/assets categories that are instantiated in the model (typically explicitly scoped for assets, and typically implicitly scoped for risks and controls related to the asset). The profile information correspond to the associated categories (and as such will be gathered from these scoped categories. Some embodiments use templates that parameterize categories of the client model and the associated risk profile that are associated to a service.

In some embodiments, the method further includes providing evaluation guidelines or parameters using evaluation templates that define how to assess scoped categories. For example, suppose there is a test component for “Administrative Access Control” controls on “Server System” assets. For this example, there may be three levels of high-level evaluation-guidelines (e.g., recommended, partial, none) meant to guide analysts translate the results they input. This provides standardization (e.g., mitigate biases and personal interpretations) regardless of which analyst performs the assessment. The example is descriptive but can be paired with more prescriptive evaluation-guidelines (e.g., based on a server's operating system, etc.). Normalizing is a separate concept (from standardization); with normalization, evaluations between disparate methodologies are normalized and/or correlated. For example, if one methodology evaluates firewall rules to be sufficiently “in place” and in another methodology that equivalent is between an 8 and 10 on a scale of 10). Some embodiments define these translations to help automate the translation between methodologies so as to find equivalencies.

In some embodiments, the method further includes normalizing correlated information for translating equivalent evaluation results between disparate evaluation methodologies.

Some embodiments generate assessments for existing control framework standards based on the results of assessments performed for other control framework standards (e.g., if a ISO27002: 2022 assessment and CIS Control 8 assessment were performed for a client, generate a proximate equivalency NIST CSF).

In some embodiments, the method further includes generating an assessment of how different audits in an operator's context for the existing computer system are related to one another. For example, a normalized-control-framework is synthesized based on best practices from other information security and/or cybersecurity reference-control-frameworks (e.g., ISO27000 and NIST CSF). The normalized framework may be related/mapped against the different reference frameworks used (e.g., related via their respective categorization representations in the system). The normalized-control-framework may be used as the main source of control categorization in the client models (which contain representations of “computer systems”). It is possible to evaluate against the normalized-control-framework definitions to map to the reference-control-frameworks. Some embodiments also approximate equivalencies from the normalized-control-framework to the reference-control-frameworks. Normalizing assessment results may also include determining and/or defining reasonable translation equivalences between disparate methods, and/or generating reasonable approximations.

In some embodiments, the method further includes interfacing with, and providing the multi-partite graph and associated risk profile, to one or more services selected from the group consisting of: e-mail protection, managed detection and response, managed perimeter defense, Vulnerability Management as a Service (VMaaS), automation of patching assessment scoring from system coverage, patch level, and timeliness statistics, threat modeler including providing supplementary tactical threat intelligence information and context, and privacy practice assessment that layers onto and assesses an operator's privacy business context. Example use cases and how these services may interact with the system are described below for illustration purposes.

The client model may be used to answer different types of questions around a shared context, and/or answer questions from a different perspective. For example, looking at a client model from an IT perspective versus an OT environment perspective may help answer what risk profile may be suitable for the principle of availability for OT environment. The client model may also be viewed from the perspective of privacy, to identify related privacy risks and/or to adjust risk profile information to reflect the severity of compromised privacy information to individuals.

Some embodiments automate assessments for portions of the client model (e.g., feed profile information to enrich the client model). For example, if the client model models computer systems, and if these computer systems related risks are also related to patching controls, and if there are metrics (e.g., patching coverage, level, timeliness) about patching activities, such as from VMaaS, then these metrics can be used to automatically update the quality of patching controls in the client model. Example services that may contribute to assessment in this manner include VMaaS, Managed Perimeter Defense, Managed Detection and Response, and e-mail protection. The client model may also be used to gain or consume insight for decision-making (e.g., to consume risk results and result comparisons from the client model). If the VMaaS services needs insights to be able to decide which computer systems to patch in first priority versus last priority, then VMaaS could consume risk results from the system to know which computer system has the greatest loss potential without their service, for example. Example services that may benefit from client model information include VMaaS, Managed Perimeter Defense, Managed Detection and Response, and threat modeler.

The client model may be used to gain or consume business/ecosystem context insights. For example, the categories and relations within the client model may be viewed to gain a better understanding of the client context. As another example, suppose MSS Core is planning a new firewall deployment, then the MSS Core analyst could consume the client model as an equivalency to a logical diagram or other information as one source of information their planning/strategizing for a firewall deployment. In this regard, example services that may benefit from client model information include VMaaS, Managed Perimeter Defense, Managed Detection and Response, and threat modeler.

The client model may also be used to build on and extend modeling (e.g., to add new categories and relate them to) for the existing information systems. For example, threat modeler is interested in the asset, risk and control categories within the client model, but they are also interested in attack and vulnerability information. Threat modeler can leverage the capabilities of the system to add attack and vulnerability categories and interrelate them to the existing client model. They can also populate the extended client model with the profile information that is relevant to them. Further, this extended portions of the client model can also be available to other services interested in these added details.

In some embodiments, identifying potential changes (e.g., control implementations, etc.) to the existing information system (including computer systems) to address the identified risk includes presenting the identified risk to an operator of the existing information systems, presenting risk remediation options (i.e., proposed control sets), to enable them to make informed business decision on risk treatment investments.

In some embodiments, the method further includes generating and displaying a visualization of forecast for the identified risk in different representations, including comparison in relation to client risk tolerances.

In some embodiments, the visualization is presented on a per risk basis or a per risk subset basis.

In some embodiments, identifying potential changes to the existing information systems (including computer systems) to address the identified risk includes prioritizing information security (including cybersecurity) initiatives corresponding to the identified risk.

In some embodiments, the method further includes identifying potential changes to the existing information systems (including computer systems) to address the identified risk includes computing and displaying expenditures, annual loss expectancy, return on investment, based on control projections and cost estimations, and/or a comparison to other organization in a same industry as the client, for the identified risk.

In some embodiments, the method further includes identifying potential changes to the existing information systems (including computer systems) to address the identified risk includes simulating how an outsourced service or project is likely to improve a client's information security (including cybersecurity) posture with respect to the identified risk.

The techniques described herein may be used for categorization, modeling and profiling services, and address several problems with conventional systems. Some embodiments provide a service to flexibly template and attribute data categorizations in accordance with the various representations observed in the wild (e.g., control frameworks without needing to shochorn into an incongruent format). Some embodiments provide a service to template mappings between categories (and templated categorizations) of the same categorization type with ability to specify set relations (e.g., map between control frameworks including any mapping interpretation by different groups). Some embodiments provide a service to template compositional representations of categories including functional and compositional relationships. Some embodiments provide an ability to define categorization types and ascribing them to both templated categorizations and to individual categories (e.g., assets, risks, controls, vulnerabilities, attacks, objectives, organization, etc.). Some embodiments provide an ability to define relationships between categories of different categorization types including functional relationship (e.g., controls ‘help achieve’ business objectives; risks ‘uncertainly negatively impact’ assets; etc.). Some embodiments provide a service to template mappings between categories (and templated categorizations) of different categorization types with ability to used defined functional relationships. Some embodiments provide a service to template mappings across templated categorizations (and categories) over their evolution including set relationships (e.g., track and traverse frameworks across versions. Some embodiments provide an ability to variably publish and require categories and templates (e.g., deprecate frameworks; track standards changes; deploy updates).

Some embodiments provide business contextual categorization, modeling, and profiling services. This includes the ability to assemble, mine, and evolve a shared collaborative model of a client's business context, the ability to build a sustainable library of highly interconnected frameworks of virtually any shapes, sizes, and versions (e.g., established, internal, custom). A versatile foundation grounded in business context is provided upon which the following may be built: scoping, definitions, and correlations of mandates and services; automated generation of entries for probabilistic risk assessments; and control offering catalog and decision making capabilities.

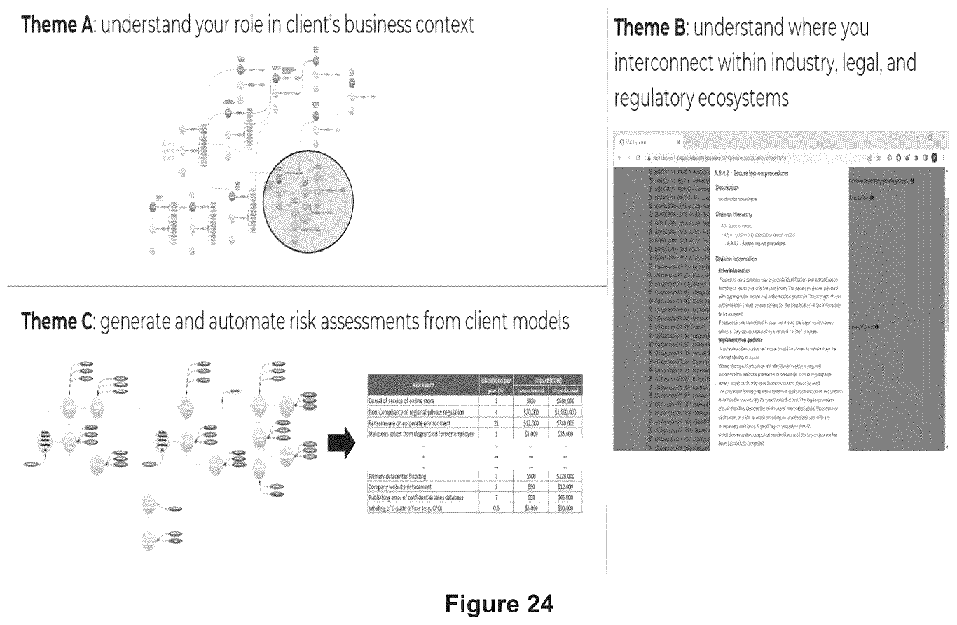

FIG. 24 is a schematic diagram of example applications, according to some embodiments. Various services (sometimes referred to as applications) may be implemented based on a shared business context model. For example, in theme A, a client can understand its role in client's business context. In them B, a client can understand where they interconnect within industry, legal and regulatory ecosystems. In theme C, a client can generate and automate risk assessments from client models.

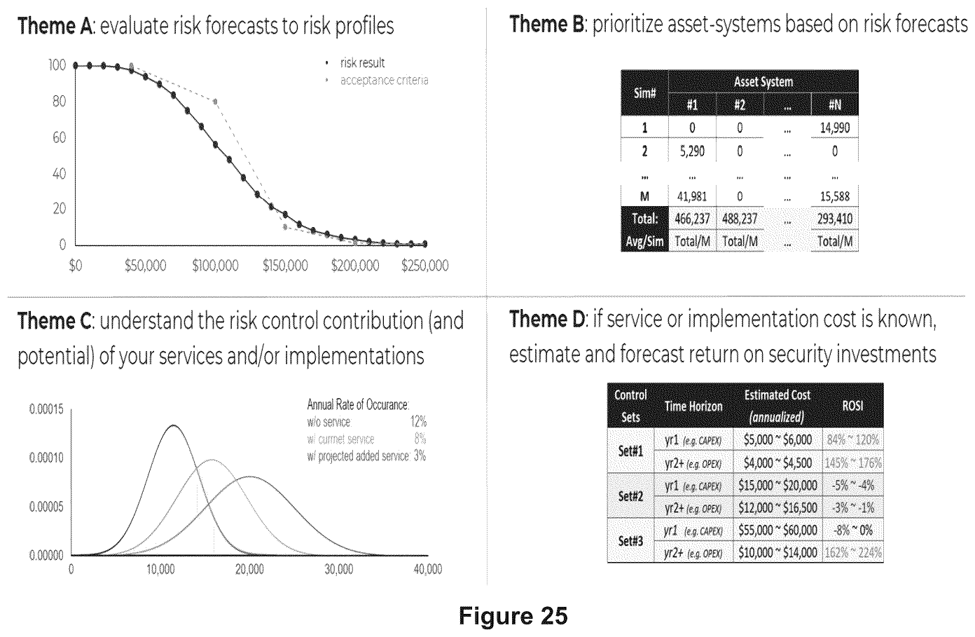

FIG. 25 is a schematic diagram of example visualizations for risk informed decisions, according to some embodiments. In theme A, the system evaluates risk forecasts to risk profiles. In them B, the system prioritizes asset systems based on risk forecasts. In theme C, the system helps a client understand the risk control contribution and potential of their services and/or implementations. In theme D, if service or implementation cost is known, estimate and forecast return on security investments.

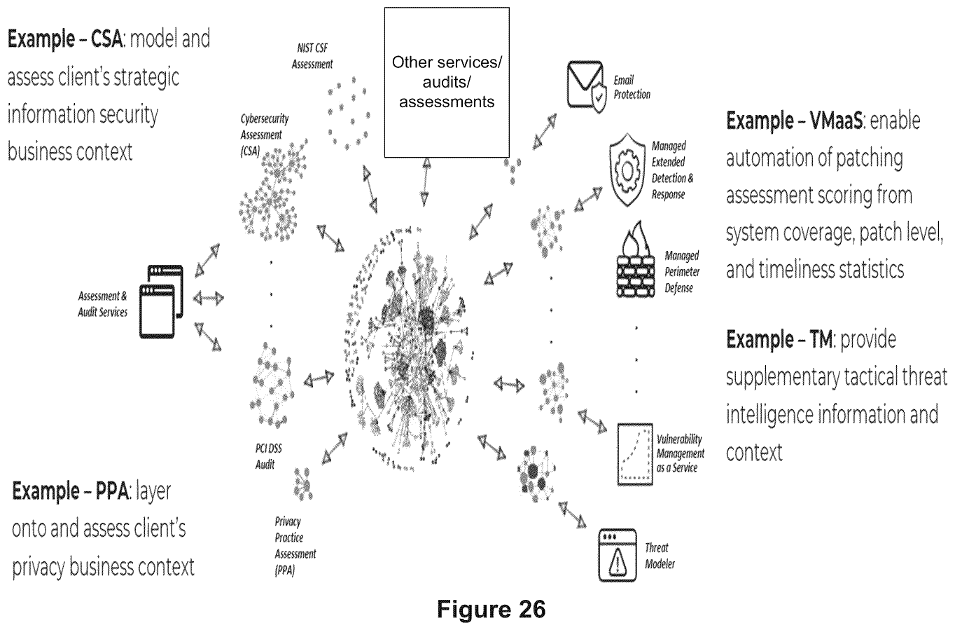

FIG. 26 is a schematic diagram of example interfaces with security services, according to some embodiments. This schematic is similar to FIG. 6, with examples. Based on their security sub-domain, each service can help automate sections of an ongoing assessment. For example, a cybersecurity assessment (CSA) can help model and assess client's strategic information security business context. A privacy practice assessment (PPA) can layer onto and assess client's privacy business context. VMaaS can enable automation of patching assessment scoring from system coverage, patch level and timeliness statistics. Threat Modeler (TM) can provide supplementary tactical threat intelligence information and context.

While embodiments and alternatives have been disclosed and discussed, the invention herein is not limited to the particular disclosed embodiments or alternatives but encompasses the full breadth and scope of the invention including equivalents, and the invention is not limited except as set forth in and encompassed by the full breadth and scope of the claims herein.

What is claimed is:

1. A method for identifying and addressing information security risks of existing information system, the method comprising:
obtaining a plurality of information security and cybersecurity frameworks:
synthesizing the plurality of information security and cybersecurity frameworks to obtain a normalized information security framework;
obtaining information on existing information systems;
generating, from the information, based on the normalized information security framework and customer business context, a risk model that is structured to account for customers' information security ecosystem;
analyzing the risk model's graph structures to identify information security risk; and
identifying and proposing prioritizing changes to the existing information systems to attempt to address the identified risk.

2. The method of claim 1, wherein each information security and cybersecurity framework includes a taxonomy of risks, controls and/or assets.

3. The method of claim 1, wherein synthesizing the plurality of information security and cybersecurity frameworks uses predetermined libraries of categorizations and templates.

4. The method of claim 1, wherein synthesizing the plurality of information security and cybersecurity frameworks comprises addressing biases and variability across the plurality of information security and cybersecurity frameworks.

5. The method of claim 1, wherein the risk model comprises a multipartite graph comprising nodes representing risks, controls and/or assets, and edges representing relationships between the nodes.

6. The method of claim 1, wherein analyzing the risk model's graph structures comprises:
traversing the risk model's graph structures to identify risk entries for risk simulations; and
populating information in the risk entries at least in part from a risk profile associated with the existing information systems.

7. The method of claim 6, wherein the risk profile is customizable by an operator of the existing information systems.

8. The method of claim 6, wherein the risk profile includes templated risk-profile likelihood parameters per risk categorization and per North American Industry Classification System (NAICS) categorization, wherein the risk-profile likelihood parameters are customizable per client context, and wherein data for the risk-profile likelihood parameters includes ranges for controls.

9. The method of claim 1, wherein a client's information security business context represented on a client model is populated with risk profile information associated with its existing information systems towards statistical analysis of risk.

10. The method of claim 9, wherein the statistical analysis comprises:
identifying one or more control sets that are most correlated to most significant risks;
projecting the one or more control sets into a copy of the client model; and
forecasting risk adjusted by the one or more control sets by reapplying one or more risk methods used to generate a risk forecast of the client model.

11. The method of claim 9, wherein the statistical analysis comprises:
generating risks from scoped portions of the client model; and
aggregating, managing, and/or filtering lists of risks and their uncertain parameters, such as probabilities, duration ranges, and impact ranges.

12. The method of claim 9, wherein the statistical analysis comprises:
forecasting probabilities and financial impacts by repeatedly simulating over a multiplicity of uncertain outcomes occurring across complex systems.

13. The method of claim 9, wherein the statistical analysis comprises:
storing and reusing random outputs generated in simulations towards standardizing control projection comparison.

14. The method of claim 9, wherein the statistical analysis comprises:
performing a series of trials that simulates occurrence and impact of potential risk events; and
for each trial, summarizing simulated loss occurrences.

15. The method of claim 1, wherein the information on the existing information systems is updated and/or obtained from one or more compliance audits or assessments of security risks for the existing information systems.

16. The method of claim 1, wherein results of a risk assessment are reconfigurable per predefined categories.

17. The method of claim 1, further comprising:
autogenerating risk events based on relationships between modelled asset and risk categorizations, wherein the risk categorizations are related to one or more asset categorizations.

18. The method of claim 1, further comprising:
adjusting a plurality of risk categorizations based on a single control categorization.

19. The method of claim 1, further comprising:
adjusting a single risk categorization based on a plurality of control categorizations, including handling residual risk likelihoods from adjacent controls using a weighted average mechanism.

20. The method of claim 1, further comprising:
adjusting risk categorizations based on layered control categorizations, including handling residual risk likelihoods from layered controls using a probability calculation that both controls occur.

21. The method of claim 1, further comprising:
adjusting one or more risk-profile parameters according to related controls, including decreasing generic risk-profile likelihood parameters based on quality of related control, mitigating impact parameters by insurance coverage, and mitigating event duration parameters by incident response.

22. The method of claim 1, further comprising:
providing interfaces to a client model and an associated risk profile, comprising:
scoping sections of the client model and the associated risk profile using templates that parameterize categories of the client model and the associated risk profile that are associated with a service;
providing evaluation guidelines or parameters using evaluation templates that define how to assess scoped categories; and
normalizing correlated information for translating equivalent evaluation results between disparate evaluation methodologies.

23. The method of claim 1, further comprising:
generating assessments for existing control framework standards based on results of assessments performed for other control framework standards.

24. The method of claim 1, further comprising:
generating an assessment of how different audits in an operator's context for the existing information system are related to one another.

25. The method of claim 1, further comprising:
interfacing with, and providing the risk model's graph and associated risk profile, to one or more services selected from the group consisting of: e-mail protection, managed detection and response, managed perimeter defense, Vulnerability Management as a Service (VMaaS), automation of patching assessment scoring from system coverage, patch level, and timeliness statistics, threat modeler including providing supplementary tactical threat intelligence information and context, and privacy practice assessment that layers onto and assesses an operator's privacy business context.

26. The method of claim 1, wherein identifying potential changes to the existing information system to address the identified risk comprises:
presenting the identified risk to an operator of the existing information systems, presenting risk remediation options, to enable them to make informed business decision on risk treatment investments.

27. The method of claim 1, further comprising:
generating and displaying a visualization of forecast for the identified risk in different representations, including comparison in relation to client risk tolerances.

28. The method of claim 27, wherein the visualization is presented on a per risk basis or a per risk subset basis.

29. The method of claim 1, wherein identifying potential changes to the existing information systems to address the identified risk comprises:
prioritizing information security initiatives corresponding to the identified risk.

30. The method of claim 1, wherein identifying potential changes to the existing information systems to address the identified risk comprises:
computing and displaying expenditures, annual loss expectancy, return on investment, based on control projections and cost estimations, and a comparison to other organization in a same industry as a client, for the identified risk.

31. The method of claim 1, wherein identifying potential changes to the existing information systems to address the identified risk comprises:
simulating how an outsourced service or project is likely to improve a client's information security posture with respect to the identified risk.

32. A computer system for identifying and addressing information security risks of existing information system, the computer system comprising:
one or more processors; and
memory;
wherein the memory stores one or more programs configured for execution by the one or more processors, and the one or more programs comprising instructions for:
obtaining a plurality of information security and cybersecurity frameworks;
synthesizing the plurality of information security and cybersecurity frameworks to obtain a normalized information security framework;
obtaining information on existing information systems;
generating, from the information, based on the normalized information security framework and customer business context, a risk model that is structured to account for customers' information security ecosystem;
analyzing the risk model's graph structures to identify information security risk; and
identifying and proposing prioritizing changes to the existing information systems to attempt to address the identified risk.

33. A non-transitory computer readable storage medium storing one or more programs configured for execution by a computer system having one or more processors, and memory, the one or more programs comprising instructions for:
obtaining a plurality of information security and cybersecurity frameworks;
synthesizing the plurality of information security and cybersecurity frameworks to obtain a normalized information security framework;
obtaining information on existing information systems;
generating, from the information, based on the normalized information security framework and customer business context, a risk model that is structured to account for customers' information security ecosystem;
analyzing the risk model's graph structures to identify information security risk; and
identifying and proposing prioritizing changes to the existing information systems to attempt to address the identified risk.
